(19) United States
(12) Patent Application Publication
(10) Pub. No.: US 2025/0233712 A1
(43) Pub. Date: Jul. 17, 2025

(54) METHOD AND APPARATUS FOR MULTICAST RECEPTIONS ON MULTIPLE CARRIERS

(71) Applicant: LENOVO (BEIJING) LIMITED, BEIJING (CN)

(72) Inventor: HAIPENG LEI, BEIJING (CN)

(21) Appl. No.: 18/730,772

(22) PCT Filed: Jan. 21, 2022
(86) PCT No.: PCT/CN2022/073211

§ 371 Date: Jul. 21, 2024

(51) Int. Cl. H04L 5/00; H04L 27/26; H04W 72/23

(52) U.S. Cl. CPC H04L 5/0055; H04L 27/2607; H04W 72/23

(57) ABSTRACT

Embodiments of the present disclosure relate to multicast receptions on multiple carriers. According to some embodiments of the disclosure, a UE for wireless communication includes a processor that is configured to cause the UE to: receive a first plurality of DCI formats scheduling a first plurality of PDSCHs on a first set of carriers, wherein a CRC of each of the first plurality of DCI formats is scrambled by a first RNTI specific to the UE; receive a second plurality of DCI formats scheduling a second plurality of PDSCHs on a second set of carriers, wherein a CRC of each of the second plurality of DCI formats is scrambled by a second RNTI common to a first group of UEs including the UE; and transmit a HARQ-ACK codebook including HARQ-ACK information bits for the first plurality of PDSCHs and the second plurality of PDSCHs.

### TECHNICAL FIELD

Embodiments of the present disclosure generally relate to wireless communication technology, and more particularly to multicast receptions on multiple carriers.

### BACKGROUND

Wireless communication systems are widely deployed to provide various telecommunication services, such as telephony, video, data, messaging, broadcasts, and so on. Wireless communication systems may employ multiple access technologies capable of supporting communication with multiple users by sharing available system resources (e.g., time, frequency, and power). Examples of wireless communication systems may include fourth generation (4G) systems, such as long term evolution (LTE) systems, LTE-advanced (LTE-A) systems, or LTE-A Pro systems, and fifth generation (5G) systems which may also be referred to as new radio (NR) systems.

In a wireless communication system, a user equipment (UE) may monitor a physical downlink control channel (PDCCH) in one or more search spaces. The PDCCH may carry downlink control information (DCI), which may schedule uplink channels, such as a physical uplink shared channel (PUSCH), or downlink channels, such as a physical downlink shared channel (PDSCH). In the case that a DCI schedules a PDSCH, the UE may transmit hybrid automatic repeat request acknowledgement (HARQ-ACK) feedback (e.g., HARQ-ACK information bit(s)) for the PDSCH through a PUSCH or a physical uplink control channel (PUCCH). For example, the PUCCH may carry a HARQ-ACK codebook including the HARQ-ACK feedback information bit(s) for the PDSCH.

The industry desires technologies for facilitating HARQ-ACK codebook determination in a communication system.

### SUMMARY

Some embodiments of the present disclosure provide a user equipment (UE). The UE may include a processor, and a transceiver coupled to the processor. The transceiver may be configured to: receive a first plurality of downlink control information (DCI) formats scheduling a first plurality of physical downlink shared channels (PDSCHs) on a first set of carriers, wherein a cyclic redundancy check (CRC) of each of the first plurality of DCI formats is scrambled by a first radio network temporary identifier (RNTI) specific to the UE; receive a second plurality of DCI formats scheduling a second plurality of PDSCHs on a second set of carriers, wherein a CRC of each of the second plurality of DCI formats is scrambled by a second RNTI common to a first group of UEs including the UE; and transmit a hybrid automatic repeat request acknowledgement (HARQ-ACK) codebook comprising HARQ-ACK information bits for the first plurality of PDSCHs and the second plurality of PDSCHs.

Some embodiments of the present disclosure provide a base station (BS). The BS may include a processor, and a transceiver coupled to the processor. The transceiver may be configured to: transmit, to a user equipment (UE), a first plurality of downlink control information (DCI) formats scheduling a first plurality of physical downlink shared channels (PDSCHs) on a first set of carriers, wherein a cyclic redundancy check (CRC) of each of the first plurality of DCI formats is scrambled by a first radio network temporary identifier (RNTI) specific to the UE; transmit, to a first group of UEs including the UE, a second plurality of DCI formats scheduling a second plurality of PDSCHs on a second set of carriers, wherein a CRC of each of the second plurality of DCI formats is scrambled by a second RNTI common to the first group of UEs; and receive, from the UE, a hybrid automatic repeat request acknowledgement (HARQ-ACK) codebook comprising HARQ-ACK information bits for the first plurality of PDSCHs and the second plurality of PDSCHs.

Some embodiments of the present disclosure provide a method for wireless communication performed by a UE. The method may include: receiving a first plurality of DCI formats scheduling a first plurality of PDSCHs on a first set of carriers, wherein a CRC of each of the first plurality of DCI formats is scrambled by a first RNTI specific to the UE; receiving a second plurality of DCI formats scheduling a second plurality of PDSCHs on a second set of carriers, wherein a CRC of each of the second plurality of DCI formats is scrambled by a second RNTI common to a first group of UEs including the UE; and transmitting a HARQ-ACK codebook including HARQ-ACK information bits for the first plurality of PDSCHs and the second plurality of PDSCHs.

Some embodiments of the present disclosure provide a method for wireless communication performed by a BS. The method may include: transmitting, to a UE, a first plurality of DCI formats scheduling a first plurality of PDSCHs on a first set of carriers, wherein a CRC of each of the first plurality of DCI formats is scrambled by a first RNTI specific to the UE, transmitting, to a first group of UEs including the UE, a second plurality of DCI formats scheduling a second plurality of PDSCHs on a second set of carriers, wherein a CRC of each of the second plurality of DCI formats is scrambled by a second RNTI common to the first group of UEs; and receiving, from the UE, a HARQ-ACK codebook comprising HARQ-ACK information bits for the first plurality of PDSCHs and the second plurality of PDSCHs.

Some embodiments of the present disclosure provide an apparatus. According to some embodiments of the present disclosure, the apparatus may include: at least one non-transitory computer-readable medium having stored thereon computer-executable instructions; at least one receiving circuitry; at least one transmitting circuitry; and at least one processor coupled to the at least one non-transitory computer-readable medium, the at least one receiving circuitry and the at least one transmitting circuitry, wherein the at least one non-transitory computer-readable medium and the computer executable instructions may be configured to, with the at least one processor, cause the apparatus to perform a method according to some embodiments of the present disclosure.

### BRIEF DESCRIPTION OF THE DRAWINGS

In order to describe the manner in which the advantages and features of the disclosure can be obtained, a description of the disclosure is rendered by reference to specific embodiments thereof, which are illustrated in the appended drawings. These drawings depict only exemplary embodiments of the disclosure and are not therefore to be considered limiting of its scope.

FIG. 1 illustrates a schematic diagram of a wireless communication system in accordance with some embodiments of the present disclosure;

FIGS. 2-5 illustrate a schematic diagram of HARQ-ACK codebook determination in accordance with some embodiments of the present disclosure;

FIG. 6 illustrates a flow chart of an exemplary procedure of wireless communications in accordance with some embodiments of the present disclosure;

FIG. 7 illustrates a flow chart of an exemplary procedure of wireless communications in accordance with some embodiments of the present disclosure; and

FIG. 8 illustrates a block diagram of an exemplary apparatus in accordance with some embodiments of the present disclosure.

### DETAILED DESCRIPTION

The detailed description of the appended drawings is intended as a description of the preferred embodiments of the present disclosure and is not intended to represent the only form in which the present disclosure may be practiced. It should be understood that the same or equivalent functions may be accomplished by different embodiments that are intended to be encompassed within the spirit and scope of the present disclosure.

Reference will now be made in detail to some embodiments of the present disclosure, examples of which are illustrated in the accompanying drawings. To facilitate understanding, embodiments are provided under a specific network architecture(s) and new service scenarios, such as the 3rd generation partnership project (3GPP) 5G (NR), 3GPP long-term evolution (LTE) Release 8, and so on. It is contemplated that along with the developments of network architectures and new service scenarios, all embodiments in the present disclosure are also applicable to similar technical problems; and moreover, the terminologies recited in the present disclosure may change, which should not affect the principles of the present disclosure.

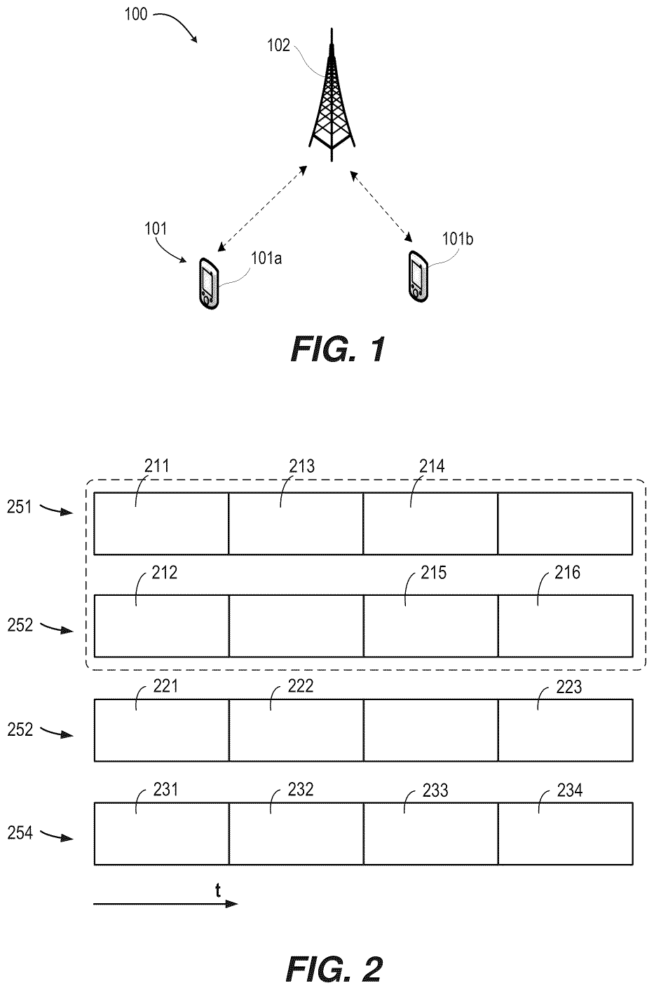

FIG. 1 illustrates a schematic diagram of a wireless communication system 100 in accordance with some embodiments of the present disclosure.

As shown in FIG. 1, wireless communication system 100 may include some UEs 101 (e.g., UE 101a and UE 101b) and a base station (e.g., BS 102). Although a specific number of UEs 101 and BS 102 are depicted in FIG. 1, it is contemplated that any number of UEs and BSs may be included in the wireless communication system 100.

The UE(s) 101 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. According to some embodiments of the present disclosure, the UE(s) 101 may include a portable wireless communication device, a smart phone, a cellular telephone, a flip phone, a device having a subscriber identity module, a personal computer, a selective call receiver, or any other device that is capable of sending and receiving communication signals on a wireless network. In some embodiments of the present disclosure, the UE(s) 101 includes wearable devices, such as smart watches, fitness bands, optical head-mounted displays, or the like. Moreover, the UE(s) 101 may be referred to as a subscriber unit, a mobile, a mobile station, a user, a terminal, a mobile terminal, a wireless terminal, a fixed terminal, a subscriber station, a user terminal, or a device, or described using other terminology used in the art. The UE(s) 101 may communicate with the BS 102 via uplink (UL) communication signals.

The BS 102 may be distributed over a geographic region. In certain embodiments of the present disclosure, the BS 102 may also be referred to as an access point, an access terminal, a base, a base unit, a macro cell, a Node-B, an evolved Node B (eNB), a gNB, a Home Node-B, a relay node, or a device, or described using other terminology used in the art. The BS 102 is generally a part of a radio access network that may include one or more controllers communicably coupled to one or more corresponding BSs 102. The BS 102 may communicate with UE(s) 101 via downlink (DL) communication signals.

The wireless communication system 100 may be compatible with any type of network that is capable of sending and receiving wireless communication signals. For example, the wireless communication system 100 is compatible with a wireless communication network, a cellular telephone network, a time division multiple access (TDMA)-based network, a code division multiple access (CDMA)-based network, an orthogonal frequency division multiple access (OFDMA)-based network, an LTE network, a 3GPP-based network, a 3GPP 5G network, a satellite communications network, a high altitude platform network, and/or other communications networks.

In some embodiments of the present disclosure, the wireless communication system 100 is compatible with 5G NR of the 3GPP protocol. For example, BS 102 may transmit data using an orthogonal frequency division multiple (OFDM) modulation scheme on the DL and the UE(s) 101 may transmit data on the UL using a discrete Fourier transform-spread-orthogonal frequency division multiplexing (DFT-S-OFDM) or cyclic prefix-OFDM (CP-OFDM) scheme. More generally, however, the wireless communication system 100 may implement some other open or proprietary communication protocols, for example, WiMAX, among other protocols.

In some embodiments of the present disclosure, the BS 102 and UE(s) 101 may communicate using other communication protocols, such as the IEEE 802.11 family of wireless communication protocols. Further, in some embodiments of the present disclosure, the BS 102 and UE(s) 101 may communicate over licensed spectrums, whereas in some other embodiments, the BS 102 and UE(s) 101 may communicate over unlicensed spectrums. The present disclosure is not intended to be limited to the implementation of any particular wireless communication system architecture or protocol.

In some embodiments of the present disclosure, a wireless communication system may support multicast and broadcast services (MBSs). For example, one or more UEs (e.g., UE 101a and UE 101b) may be grouped as an MBS group to receive an MBS(s) (e.g., an MBS PDSCH) from a BS (e.g., BS 102).

A group-common radio network temporary identifier (RNTI) (e.g., group-RNTI (G-RNTI)) is introduced for an MBS so that a UE can differentiate a DCI format (hereinafter may referred to as “group-common DCI format” or “multicast DCI format”) scheduling a group-common PDSCH carrying an MBS service (e.g., an MBS PDSCH) from a DCI format scheduling a UE-specific PDSCH carrying a unicast service. For example, the cyclic redundancy check (CRC) of the DCI format (hereinafter may be referred to as “UE-specific DCI format” or “unicast DCI format”) scheduling the unicast PDSCH may be scrambled by a UE-specific RNTI (e.g., cell-RNTI (C-RNTI)) and the scheduled unicast PDSCH may also be scrambled by the UE-specific RNTI. The CRC of the DCI format scheduling the group-common PDSCH may be scrambled by a G-RNTI and the scheduled group-common PDSCH carrying the MBS may also be scrambled by the G-RNTI. When a UE supports multiple MBS services, each service may be configured with a G-RNTI specific to the service. In other words, from a UE's perspective, the G-RNTIs can be used to differentiate the multiple MBS services.

On the other hand, a wireless communication system may support carrier aggregation (CA), which may also be referred to as spectrum aggregation or bandwidth aggregation. Under CA, a plurality of carriers may be configured for improving a data rate(s). An individual unit frequency bound by CA may be referred to as a component carrier (CC). A CC may correspond to a serving cell. CA may provide the same effect as the case in which a plurality of bands, which are physically continuous or non-continuous in the frequency domain, are bound and used as a logically large band. In some examples, a wireless communication system (e.g., NR system) may support a maximum of 16 component carriers (CCs) in the case of carrier aggregation (CA), or a maximum of 32 CCs in the case of dual connectivity (DC).

In some embodiments of the present disclosure, CA configuration may be applied to a unicast service. For example, a plurality of DCI formats may schedule a plurality of PDSCHs specific to a UE on a plurality of carriers (including, for example, a primary cell (PCell) and at least one secondary cell (SCell) of the UE).

In some embodiments of the present disclosure, CA configuration may be applied to a multicast service(s). This would be useful and beneficial because, for example, using a SCell for a multicast transmission can help the network to balance the load of unicast and multicast services in a PCell when, for example, the multicast transmission in the PCell leads to a high load of the network.

Since CA configuration is UE-specific, a CA-capable UE may use its SCell for receiving a multicast while this SCell may be a PCell for another CA-capable UE or even a CA-incapable UE. However, by properly configuring the common frequency resource (CFR) for a group-common PDCCH and the CFR for a group-common PDSCH, the multicast reception of a CA-capable UE would have no impact on the multicast reception of a CA-incapable UE.

The present disclosure does not limit the number of carriers for carrying a specific multicast service. For example, a UE may be configured with a plurality of carriers and may support at least one multicast service and a unicast service. One or more services (unicast or multicast) may be configured on the same carrier.

In some embodiments, each service may only be configured on a corresponding one of the plurality of carriers while one or more services may be configured on the same carrier of the plurality of carriers. For instance, the UE is configured to receive a multicast service (e.g., multicast service #1) on one SCell of the UE via, for example, self-scheduling (e.g., the DCI formats and PDSCHs for multicast service #1 are transmitted on this SCell), the UE does not expect to simultaneously receive multicast service #1 on a PCell or another SCell of the UE.

In some embodiments, a service (unicast or multicast) may be configured on at least one carrier of the plurality of carriers supported by the UE. For example, the UE may be configured to receive a service (unicast or multicast) on two or more carriers (e.g., including carrier #1 and carrier #2) of the plurality of carriers, with self-scheduling or cross-carrier scheduling. The UE may be configured to receive another service (unicast or multicast) on one or more carriers (e.g., including carrier #3) of the plurality of carriers. Carrier #3 may be a different carrier from carrier #1 and carrier #2, or may be carrier #1 or carrier #2.

When CA configuration is extended to multicast, how to determine a HARQ-ACK codebook multiplexing HARQ-ACK feedback for a unicast and at least one multicast service may become an issue. Moreover, both unicast service and multicast service supports several types of HARQ-ACK codebooks including, for example, a Type-1 HARQ-ACK codebook (also referred to as “semi-static HARQ-ACK codebook”) and a Type-2 HARQ-ACK codebook (also referred to as “dynamic HARQ-ACK codebook”). How to determine a HARQ-ACK codebook multiplexing HARQ-ACK feedback for a unicast and at least one multicast service which are configured with respective HARQ-ACK codebook type(s) may become an issue.

Embodiments of the present disclosure provide solutions for HARQ-ACK codebook determination. For example, solutions for determining a HARQ-ACK codebook that can solve the above issues are proposed. For example, when a PDSCH-to-HARQ_timing field in the DCI formats for a unicast service and at least one multicast service indicates the same uplink slot for transmitting the HARQ-ACK feedback, solutions for determining a HARQ-ACK codebook carrying the HARQ-ACK feedback for the unicast service and the at least one multicast service are proposed. More details on the embodiments of the present disclosure will be illustrated in the following text in combination with the appended drawings.

In the following embodiments, it is assumed that CA configuration is applied to the unicast and multicast services supported at a UE. For example, the UE may be configured to receive a unicast service and at least one multicast service on a plurality of carriers (e.g., a plurality of serving cells) configured to the UE. It is also assumed that the HARQ-ACK feedback for the unicast and multicast service(s) is to be multiplexed in the same slot (e.g., the same HARQ-ACK codebook).

In some embodiments of the present disclosure, when a UE is configured to receive a unicast service and at least one multicast service on a plurality of carriers, the DAIs of the DCI formats for these services may be counted per service, i.e., per RNTI.

For example, in some embodiments, the value of a DAI (e.g., a counter DAI) in a multicast DCI format (e.g., “DCI format #A1”) with the CRC scrambled by a specific G-RNTI (e.g., “G-RNTI #A1”, which corresponds to a specific multicast service, e.g., “multicast service #A1”) may indicate the accumulative number of transmitted multicast DCI formats with the CRC scrambled by G-RNTI #A1 and with HARQ-ACK feedback for the scheduled PDSCHs to be transmitted in the same slot. The accumulative number may be counted up to the current serving cell (e.g., the serving cell or carrier where DCI format #A1 is transmitted) among a set of serving cells where the multicast DCI formats with the CRC scrambled by G-RNTI #A1 are configured to be monitored (e.g., a set of carriers configured for receiving multicast service #A1) and up to the current PDCCH monitoring occasion (e.g., the PDCCH monitoring occasion where DCI format #A1 is transmitted).

For example, the value of the DAI in a multicast DCI format for a specific multicast service may be firstly updated in a predefined order (e.g., an ascending order) of serving cell indexes among the set of serving cells where the multicast DCI formats with the CRC scrambled by a specific G-RNTI (i.e., corresponding to the specific multicast service) are configured to be monitored, and then updated in a predefined order (e.g., an ascending order) of the PDCCH monitoring occasions.

In some embodiments, a multicast DCI format may include an additional DAI (e.g., total DAI). For example, when the number of serving cells in the set of serving cells where the multicast DCI formats with the CRC scrambled by G-RNTI #A1 are configured to be monitored is greater than 1, DCI format #A1 may include a counter DAI and a total DAI. Otherwise, if the number of serving cells in the set of serving cells is 1, DCI format #A1 may only include a single DAI (e.g., counter DAI).

The total DAI in DCI format #A1 may indicate the total number of transmitted multicast DCI formats with the CRC scrambled by G-RNTI #A1 with HARQ-ACK feedback for the scheduled PDSCHs to be transmitted in the same slot. The total DAI may be counted up to the current PDCCH monitoring occasion among the set of serving cells where the multicast DCI formats with the CRC scrambled by G-RNTI #A1 are configured to be monitored.

In some embodiments, the value of a DAI (e.g., a counter DAI) in a unicast DCI format (current unicast DCI format) with the CRC scrambled by a C-RNTI may indicate the accumulative number of transmitted unicast DCI formats with the CRC scrambled by the C-RNTI. The HARQ-ACK feedback for the PDSCHs scheduled by the unicast DCI formats is to be transmitted in the same slot. The accumulative number may be counted up to the current serving cell (e.g., the serving cell or carrier where the current unicast DCI format is transmitted) among a set of serving cells where the unicast DCI formats with the CRC scrambled by the C-RNTI are configured to be monitored (e.g., a set of carriers configured for receiving the unicast service) and up to the current PDCCH monitoring occasion (e.g., the PDCCH monitoring occasion where the current unicast DCI format is transmitted).

For example, the value of the counter DAI in a unicast DCI format may be firstly updated in a predefined order (e.g., an ascending order) of serving cell indexes among the set of serving cells where the unicast DCI formats with the CRC scrambled by the C-RNTI are configured to be monitored, and then updated in a predefined order (e.g., an ascending order) of the PDCCH monitoring occasions.

In some embodiments, a unicast DCI format may include an additional DAI (e.g., total DAI). For example, when the number of serving cells in the set of serving cells where the unicast DCI formats with the CRC scrambled by the C-RNTI are configured to be monitored is greater than 1, the unicast DCI format may include a counter DAI and a total DAI. Otherwise, if the number of serving cells in the set of serving cells is 1, the unicast DCI format may only include a single DAI (e.g., counter DAI).

The total DAI in the unicast DCI format may indicate the total number of transmitted unicast DCI formats with the CRC scrambled by the C-RNTI with HARQ-ACK feedback for the scheduled PDSCHs to be transmitted in the same slot. The total DAI may be counted up to the current PDCCH monitoring occasion among the set of serving cells where the unicast DCI formats with the CRC scrambled by the C-RNTI are configured to be monitored.

The HARQ-ACK codebook may include a sub-codebook for each of the unicast service and the at least one multicast service supported at the UE. Each sub-codebook may include HARQ-ACK information bits for a specific service, for example, the unicast service or one of the at least one multicast service. Within each HARQ-ACK sub-codebook, the HARQ-ACK information bits may be ordered according to a predefined order (e.g., an ascending order) of the DAIs (e.g., the counter DAIs) of the corresponding DCI formats. In the case of multi-carrier scheduling for a specific service (e.g., the number of carriers configured for the specific service is greater than 1), the size of the corresponding HARQ-ACK sub-codebook may be determined based on the value of the total DAI for the specific service.

The HARQ-ACK sub-codebooks may be concatenated into the final HARQ-ACK codebook according to various methods.

In some embodiments, the sub-codebooks may be arranged in the HARQ-ACK codebook according to the associated serving cell indexes. For example, it is assumed that the UE is configured to receive a multicast service on carrier set #A1 and a unicast service on carrier set #B1. The UE may generate a sub-codebook for the multicast service and a sub-codebook for the unicast service. The sub-codebooks may be arranged in the final HARQ-ACK codebook according to the serving cell indexes of carrier set #A1 and carrier set #B1 (e.g., in an ascending order of the serving cell indexes). For example, assuming that carrier set #A1 is associated with serving cell index #A1, which is smaller than serving cell index #B1 associated with carrier set #B1, the sub-codebook for the multicast service may be arranged in front of the sub-codebook for the unicast service.

In the case that the associated serving cell indexes (e.g., serving cell index #A1 and serving cell index #B1) are the same, the sub-codebooks may be arranged according to the associated RNTI values. For example, the sub-codebook for the unicast service may be placed in a predefined location (e.g., as the first sub-codebook or the last sub-codebook) among the sub-codebooks associated with the same serving cell index. The sub-codebooks for the multicast services among the sub-codebooks associated with the same serving cell index may be arranged according to the associated G-RNTIs (e.g., in an ascending or descending order of the G-RNTI values configured for the corresponding multicast services).

When a carrier set (e.g., carrier set #A1 or carrier set #B1) includes a single carrier, the associated serving cell index (e.g., serving cell index #A1 or serving cell index #B1) is the serving cell index of the single carrier. When a carrier set (e.g., carrier set #A1 or carrier set #B1) includes more than one carrier, the associated serving cell index (e.g., serving cell index #A1 or serving cell index #B1) is a specific (e.g., the lowest or highest) serving cell index among the more than one carrier.

In some embodiments, the sub-codebooks may be arranged in the HARQ-ACK codebook according to the associated RNTIs. For example, the sub-codebook for the unicast service may be placed in a predefined location (e.g., at the beginning or at the end) of the HARQ-ACK codebook. The sub-codebooks for the multicast services may be arranged in the HARQ-ACK codebook according to the associated G-RNTIs (e.g., in an ascending or descending order of the G-RNTI values configured for the corresponding multicast services). For example, the sub-codebook for the unicast service may be placed at the beginning of the HARQ-ACK codebook, and then followed by the sub-codebooks for the at least one multicast services arranged in an ascending order of the associated G-RNTI values.

In some embodiments, the sub-codebook for the unicast service may be placed in a predefined location (e.g., at the beginning or at the end) of the HARQ-ACK codebook. The sub-codebooks for the multicast services may be arranged in the HARQ-ACK codebook according to the associated serving cell indexes, the associated G-RNTIs, or any combination thereof. For example, the sub-codebooks for the multicast services may be arranged first according to the associated serving cell indexes, and then according to the associated G-RNTIs (e.g., in the case of the same associated serving cell index).

For example, the sub-codebook for the unicast service may be placed at the beginning of the HARQ-ACK codebook, and then followed by the sub-codebooks for the at least one multicast services arranged in an ascending order of the associated serving cell indexes. As stated above, the associated serving cell index may be a specific (e.g., the lowest or highest) serving cell index among the set of carriers configured for the corresponding service. In the case that two or more multicast services are associated with the same serving cell index, the sub-codebooks for the two or more multicast services may be further ordered according to the associated G-RNTIs (e.g., in an ascending or descending order of the G-RNTI values configured for the two or more multicast services).

In some embodiments, the HARQ-ACK codebook type(s) configured for the unicast service and the at least one multicast service supported at the UE can be the same or different. In some examples, a UE may be configured to receive a unicast service with a Type-2 HARQ-ACK codebook and a multicast service with a Type-1 HARQ-ACK codebook. The UE may further be configured to receive another multicast service with a Type-2 HARQ-ACK codebook. In some examples, a UE may be configured to receive a unicast service and at least one multicast service with the same HARQ-ACK codebook type (Type-1 HARQ-ACK codebook or Type-2 HARQ-ACK codebook). Each HARQ-ACK sub-codebook of a corresponding service may be generated according to the correspondingly configured HARQ-ACK codebook type. In other words, each HARQ-ACK sub-codebook is generated independently and concatenated according to the aforementioned methods.

For example, FIG. 2 illustrates a schematic diagram of HARQ-ACK codebook determination in accordance with some embodiments of the present disclosure. Referring to FIG. 2, a UE may be configured with a plurality of CCs (e.g., CCs 251-254 in FIG. 2). In some examples, unicast DCI formats may be configured to be monitored on CC 251 and CC 252. Multicast DCI formats with a CRC scrambled by a G-RNTI (e.g., G-RNTI #B1 corresponding to multicast service #B1) may be configured to be monitored on CC 253. Multicast DCI formats with a CRC scrambled by another G-RNTI (e.g., G-RNTI #B2 corresponding to multicast service #B2) are configured to be monitored only on CC 254. Therefore, a unicast DCI format may include a counter DAI and a total DAI, and the multicast DCI formats for multicast service #B1 and multicast service #B2 may only include a counter DAI, and not a total DAI.

For simplicity, it is assumed that the value of the serving cell index of CC 251<the value of the serving cell index of CC 252<the value of the serving cell index of CC 253<the value of the serving cell index of CC 254, and the value of G-RNTI #B2<the value of G-RNTI #B1.

In some examples, the total DAI in the unicast DCI format may indicate the total number of transmitted unicast DCI formats on both CC 251 and CC 252. The counter DAI in the unicast DCI format may indicate an accumulative number of transmitted unicast DCI formats on both CC 251 and CC 252 and updated in a frequency-first time-second manner on both CC 251 and CC 252. For example, assuming that unicast DCI formats 211-216 are transmitted on CC 251 and CC 252, each of unicast DCI formats 211-216 may include a counter DAI and a total DAI. The {counter DAI, total DAI} in unicast DCI formats 211-216 may indicate {1,2}, {2,2}, {3,3}, {4,5}, {5,5}, and {6,6}, respectively.

The counter DAI in a multicast DCI format for multicast service #B1 may indicate an accumulative number of transmitted DCI formats on CC 253 for multicast service #B1. The counter DAI in a multicast DCI format for multicast service #B2 may indicate an accumulative number of transmitted DCI formats on CC 254 for multicast service #B2. For example, assuming that multicast DCI formats 221-223 are transmitted on CC 253 and multicast DCI formats 231-234 are transmitted on CC 254, each of the multicast DCI formats may include a counter DAI. The values of the counter DAI in multicast DCI formats 221-223 may indicate 1, 2, and 3, respectively. The values of the counter DAI in multicast DCI formats 231-234 may indicate 1, 2, 3, and 4, respectively.

Assuming that HARQ-ACK feedback associated with unicast DCI formats 211-216, multicast DCI formats 221-223 and multicast DCI formats 231-234 is to be transmitted in the same slot, the UE may generate a HARQ-ACK codebook including respective HARQ-ACK sub-codebooks for the unicast service, multicast service #B1, and multicast service #B2, respectively. Within each HARQ-ACK sub-codebook, the HARQ-ACK information bits may be ordered according to the corresponding DAIs. For example, in the HARQ-ACK sub-codebook for multicast service #B1, HARQ-ACK information bits for the PDSCHs scheduled by multicast DCI formats 221-223 may be ordered according to an ascending order of the counter DAIs in multicast DCI formats 221-223.

As described above, various methods may be employed for arranging the three HARQ-ACK sub-codebooks in the final HARQ-ACK codebook.

In some examples, the three HARQ-ACK sub-codebooks may be arranged according to the associated serving cell indexes. For example, the sub-codebook for the unicast service may be associated with the serving cell index of CC 251, and the sub-codebooks for multicast service #B1 and multicast service #B2 may be associated with the serving cell indexes of CC 253 and CC 254, respectively. The sub-codebook for the unicast service may be placed at the beginning of the HARQ-ACK codebook, and may be followed by the sub-codebook for multicast service #B1, which may be followed by the sub-codebooks for multicast service #B2 (i.e., in an ascending order of the associated serving cell indexes).

In some examples, the three HARQ-ACK sub-codebooks may be arranged in the HARQ-ACK codebook according to the associated RNTIs. For example, the sub-codebook for the unicast service may be placed at the beginning of the HARQ-ACK codebook and may be followed by the sub-codebook for multicast service #B2, which may be followed by the sub-codebooks for multicast service #B1 (i.e., in an ascending order of the associated G-RNTIs).

In some examples, the sub-codebook for the unicast service may be placed at a predefined location of the HARQ-ACK codebook, and the two sub-codebooks for multicast service #B1 and multicast service #B2 may be arranged in the HARQ-ACK codebook according to the associated serving cell indexes. For example, the sub-codebook for the unicast service may be placed at the beginning of the HARQ-ACK codebook and may be followed by the sub-codebook for multicast service #B1, which may be followed by the sub-codebooks for multicast service #B2 (i.e., in an ascending order of the associated serving cell indexes).

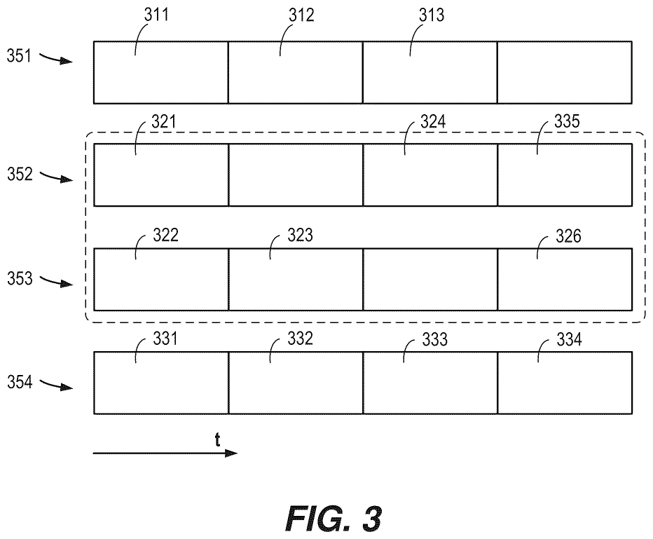

For example, FIG. 3 illustrates a schematic diagram of HARQ-ACK codebook determination in accordance with some embodiments of the present disclosure. Referring to FIG. 3, a UE may be configured with a plurality of CCs (e.g., CCs 351-354 in FIG. 3). In some examples, unicast DCI formats may be configured to be monitored on CC 351. Multicast DCI formats with a CRC scrambled by a G-RNTI (e.g., G-RNTI #C1 corresponding to multicast service #C1) may be configured to be monitored on CC 352 and CC 353. Multicast DCI formats with a CRC scrambled by another G-RNTI (e.g., G-RNTI #C2 corresponding to multicast service #C2) are configured to be monitored only on CC 354. Therefore, the unicast DCI formats and the multicast DCI formats for multicast service #C2 may only include a counter DAI, and the multicast DCI formats for multicast service #C1 may include a counter DAI and a total DAI.

For simplicity, it is assumed that the value of the serving cell index of CC 351<the value of the serving cell index of CC 352<the value of the serving cell index of CC 353<the value of the serving cell index of CC 354, and the value of G-RNTI #C2<the value of G-RNTI #C1.

In some examples, the counter DAI in the unicast DCI format may indicate an accumulative number of transmitted unicast DCI formats on CC 351. For example, assuming that unicast DCI formats 311-313 are transmitted on CC 351, each of unicast DCI formats 311-313 may include a counter DAI. The values of the counter DAI in unicast DCI formats 311-313 may indicate 1, 2, and 3, respectively.

The total DAI in a multicast DCI format for multicast service #C1 may indicate the total number of transmitted multicast DCI formats on both CC 352 and CC 353. The counter DAI in the multicast DCI format for multicast service #C1 may indicate an accumulative number of transmitted multicast DCI formats on both CC 352 and CC 353 and updated in a frequency-first time-second manner on both CC 352 and CC 353. For example, assuming that multicast DCI formats 321-326 are transmitted on CC 352 and CC 353, each of multicast DCI formats 321-326 may include a counter DAI and a total DAI. The {counter DAI, total DAI} in multicast DCI formats 321-326 may indicate {1,2}, {2,2}, {3,3}, {4,4}, {5,6}, and {6,6}, respectively.

The counter DAI in a multicast DCI format for multicast service #C2 may indicate an accumulative number of transmitted DCI formats on CC 354 for multicast service #C2. For example, assuming that multicast DCI formats 331-334 are transmitted on CC 354, each of multicast DCI formats 331-334 may include a counter DAI. The values of the counter DAI in multicast DCI formats 331-334 may indicate 1, 2, 3, and 4, respectively.

Assuming that HARQ-ACK feedback associated with unicast DCI formats 311-313, multicast DCI formats 321-326 and multicast DCI formats 331-334 are to be transmitted in the same slot, the UE may generate a HARQ-ACK codebook including respective HARQ-ACK sub-codebooks for the unicast service, multicast service #C1, and multicast service #C2, respectively. Within each HARQ-ACK sub-codebook, the HARQ-ACK information bits may be ordered according to the corresponding DAIs.

As described above, various methods may be employed for arranging the three HARQ-ACK sub-codebooks in the final HARQ-ACK codebook.

In some examples, the three HARQ-ACK sub-codebooks may be arranged according to the associated serving cell indexes. For example, the sub-codebooks for the unicast service, multicast service #C1 and multicast service #C2 may be associated with the serving cell indexes of CC 351, CC 352 and CC 354, respectively. The sub-codebook for the unicast service may be placed at the beginning of the HARQ-ACK codebook, and may be followed by the sub-codebook for multicast service #C1, which may be followed by the sub-codebooks for multicast service #C2 (i.e., in an ascending order of the associated serving cell indexes).

In some examples, the three HARQ-ACK sub-codebooks may be arranged in the HARQ-ACK codebook according to the associated RNTIs. For example, the sub-codebook for the unicast service may be placed at the beginning of the HARQ-ACK codebook and may be followed by the sub-codebook for multicast service #C2, which may be followed by the sub-codebooks for multicast service #C1 (i.e., in an ascending order of the associated G-RNTIs).

In some examples, the sub-codebook for the unicast service may be placed at a predefined location of the HARQ-ACK codebook, and the two sub-codebooks for multicast service #C1 and multicast service #C2 may be arranged in the HARQ-ACK codebook according to the associated serving cell indexes. For example, the sub-codebook for the unicast service may be placed at the beginning of the HARQ-ACK codebook and may be followed by the sub-codebook for multicast service #C1, which may be followed by the sub-codebooks for multicast service #C2 (i.e., in an ascending order of the associated serving cell indexes).

In some embodiments of the present disclosure, when a UE is configured to receive a unicast service and at least one multicast service on a plurality of carriers, the DAIs of the DCI formats for the unicast service may be counted separately from the DAIs of the DCI formats for the at least one multicast service.

For example, in some embodiments, the value of a DAI (e.g., a counter DAI) in a multicast DCI format (e.g., “DCI format #D1”) for the at least one multicast service may indicate the accumulative number of transmitted multicast DCI formats for the at least one multicast service (e.g., multicast DCI formats with the CRC scrambled by the G-RNTI(s) of the at least one multicast service) with HARQ-ACK feedback for the scheduled PDSCHs to be transmitted in the same slot. The accumulative number may be counted up to the current serving cell (e.g., the serving cell or carrier where DCI format #D1 is transmitted) among the set(s) of serving cells where the multicast DCI formats for the at least one multicast service are configured to be monitored (e.g., at least one set of carriers configured for receiving the at least one multicast service) and up to the current PDCCH monitoring occasion (e.g., the PDCCH monitoring occasion where DCI format #D1 is transmitted).

For example, the value of the DAI in a multicast DCI format may be firstly updated in a predefined order (e.g., an ascending order) of serving cell indexes among the set(s) of serving cells where the multicast DCI formats for the at least one multicast service (e.g., multicast DCI formats with the CRC scrambled by the G-RNTI(s) of the at least one multicast service) are configured to be monitored, and then updated in a predefined order (e.g., an ascending order) of the PDCCH monitoring occasions.

In some embodiments, a multicast DCI format may include an additional DAI (e.g., total DAI). For example, when the number of serving cells in the set(s) of serving cells where the multicast DCI formats for the at least one multicast service are configured to be monitored is greater than 1, DCI format #D1 may include a counter DAI and a total DAI. Otherwise, if the number of serving cells is 1, DCI format #D1 may only include a single DAI (e.g., counter DAI).

In some examples, the number of serving cells in two or more sets of serving cells may mean that the number of serving cells in a combination of two or more sets of serving cells. For example, assuming that set #1 includes cell #1 and cell #2 and set #2 includes cell #3 and cell #4, the number of serving cells in set #1 and set #2 may be 4 since four different cells are in the combination of set #1 and set #2. For example, assuming that set #3 includes cell #1 and cell #2 and set #4 includes cell #2 and cell #3, the number of serving cells in set #3 and set #4 may be 3 since three different cells are in the combination of set #3 and set #4.

The total DAI in DCI format #D1 may indicate the total number of transmitted multicast DCI formats for the at least one multicast service (e.g., multicast DCI formats with the CRC scrambled by the G-RNTI(s) of the at least one multicast service) with HARQ-ACK feedback for the scheduled PDSCHs to be transmitted in the same slot. The total DAI may be counted up to the current PDCCH monitoring occasion among the set(s) of serving cells where the multicast DCI formats for the at least one multicast service are configured to be monitored.

In some embodiments, the value of a DAI (e.g., a counter DAI) in a unicast DCI format (current unicast DCI format) with the CRC scrambled by a C-RNTI may indicate the accumulative number of transmitted unicast DCI formats with the CRC scrambled by the C-RNTI. The HARQ-ACK feedback for the PDSCHs scheduled by the unicast DCI formats is to be transmitted in the same slot. The accumulative number may be counted up to the current serving cell (e.g., the serving cell or carrier where the current unicast DCI format is transmitted) among a set of serving cells where the unicast DCI formats with the CRC scrambled by the C-RNTI are configured to be monitored (e.g., a set of carriers configured for receiving the unicast service) and up to the current PDCCH monitoring occasion (e.g., the PDCCH monitoring occasion where the current unicast DCI format is transmitted).

For example, the value of the counter DAI in a unicast DCI format may be firstly updated in a predefined order (e.g., an ascending order) of serving cell indexes among the set of serving cells where the unicast DCI formats with the CRC scrambled by the C-RNTI are configured to be monitored, and then updated in a predefined order (e.g., an ascending order) of the PDCCH monitoring occasions.

In some embodiments, a unicast DCI format may include an additional DAI (e.g., total DAI). For example, when the number of serving cells in the set of serving cells where the unicast DCI formats with the CRC scrambled by the C-RNTI are configured to be monitored is greater than 1, the unicast DCI format may include a counter DAI and a total DAI. Otherwise, if the number of serving cells in the set of serving cells is 1, the unicast DCI format may only include a single DAI (e.g., counter DAI).

The total DAI in the unicast DCI format may indicate the total number of transmitted unicast DCI formats with the CRC scrambled by the C-RNTI with HARQ-ACK feedback for the scheduled PDSCHs to be transmitted in the same slot. The total DAI may be counted up to the current PDCCH monitoring occasion among the set of serving cells where the unicast DCI formats with the CRC scrambled by the C-RNTI are configured to be monitored.

The HARQ-ACK codebook may include a sub-codebook for unicast service and a sub-codebook for multicast service. The sub-codebook for unicast service may include HARQ-ACK information bits for the unicast service. The sub-codebook for multicast service may include HARQ-ACK information bits for the at least one multicast service. Within each HARQ-ACK sub-codebook, the HARQ-ACK information bits may be ordered according to a predefined order (e.g., an ascending order) of the DAIs (e.g., the counter DAIs) of the corresponding DCI formats. When, for example, the number of carriers configured for the uncast service is greater than 1 or the number of carriers configured for the at least one multicast service is greater than 1, the size of the corresponding HARQ-ACK sub-codebook may be determined based on the value of the total DAI for the corresponding service. The sub-codebook for unicast service and the sub-codebook for multicast service may be arranged in the HARQ-ACK codebook according to a predefined order. For example, the sub-codebook for unicast service may be placed at the beginning of the HARQ-ACK codebook, and then concatenated with the sub-codebook for multicast service.

In some embodiments, the HARQ-ACK codebook type configured for the unicast service supported at the UE may be different or the same as that configured for the at least one multicast service supported at the UE. The same HARQ-ACK codebook type may be configured for the at least one multicast service. For example, a UE may be configured to receive a unicast service with a Type-2 HARQ-ACK codebook and one or more multicast services with a Type-1 HARQ-ACK codebook. The HARQ-ACK sub-codebook for the unicast service and the HARQ-ACK sub-codebook for the one or more multicast services may be generated independently from each other according to the correspondingly configured HARQ-ACK codebook type. Then, the two HARQ-ACK sub-codebooks may be concatenated according to the aforementioned methods.

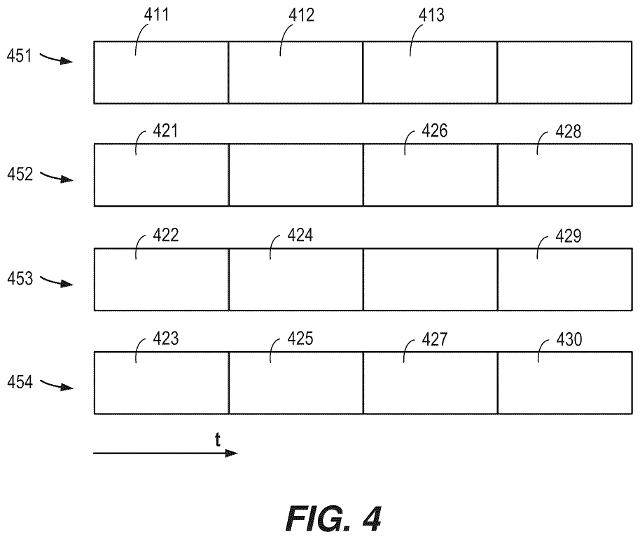

For example, FIG. 4 illustrates a schematic diagram of HARQ-ACK codebook determination in accordance with some embodiments of the present disclosure. Referring to FIG. 4, a UE may be configured with a plurality of CCs (e.g., CCs 451-454 in FIG. 4). In some examples, unicast DCI formats may be configured to be monitored on CC 451. Multicast DCI formats with a CRC scrambled by a G-RNTI (e.g., G-RNTI #E1 corresponding to multicast service #E1) may be configured to be monitored on CC 452. Multicast DCI formats with a CRC scrambled by another G-RNTI (e.g., G-RNTI #E2 corresponding to multicast service #E2) are configured to be monitored only on CC 453. Multicast DCI formats with a CRC scrambled by yet another G-RNTI (e.g., G-RNTI #E3 corresponding to multicast service #E3) are configured to be monitored only on CC 454. Therefore, the unicast DCI formats may only include a counter DAI and the multicast DCI formats for multicast services #E1- #E3 may include a counter DAI and a total DAI.

For simplicity, it is assumed that the value of the serving cell index of CC 451<the value of the serving cell index of CC 452<the value of the serving cell index of CC 453<the value of the serving cell index of CC 454.

In some examples, the counter DAI in the unicast DCI format may indicate an accumulative number of transmitted unicast DCI formats on CC 451. For example, assuming that unicast DCI formats 411-413 are transmitted on CC 451, each of unicast DCI formats 411-413 may include a counter DAI, the values of which may indicate 1, 2, and 3, respectively.

The total DAI in a multicast DCI format for any of multicast services #E1- #E3 may indicate the total number of transmitted multicast DCI formats on CCs 452-454. The counter DAI in the multicast DCI format for any of multicast services #E1- #E3 may indicate an accumulative number of transmitted multicast DCI formats on CCs 452-454 and updated in a frequency-first time-second manner on both CCs 452-454. For example, assuming that multicast DCI formats 421-430 are transmitted on CCs 452-454, wherein multicast DCI formats 421, 426 and 428 on CC 452 are for multicast service #E1, multicast DCI formats 422, 424 and 429 on CC 453 are for multicast service #E2, and multicast DCI formats 423, 425, 427 and 430 on CC 454 are for multicast service #E3, each of multicast DCI formats 421-430 may include a counter DAI and a total DAI. The {counter DAI, total DAI} value in multicast DCI formats 421-430 may indicate {1,3}, {2,3}, {3,3}, {4,5}, {5,5}, {6,7}, {7,7}, {8,10}, {9,10} and {10, 10}, respectively.

Assuming that HARQ-ACK feedback associated with unicast DCI formats 411-413 and multicast DCI formats 421-430 are to be transmitted in the same slot, the UE may generate a HARQ-ACK codebook including a HARQ-ACK sub-codebook for the unicast service and a HARQ-ACK sub-codebook for multicast services #E1- #E3. Within each HARQ-ACK sub-codebook, the HARQ-ACK information bits may be ordered according to the corresponding DAIs. As described above, the two HARQ-ACK sub-codebooks may be ordered according to a predefined order in the HARQ-ACK codebook.

In some embodiments of the present disclosure, when a UE is configured to receive a unicast service and at least one multicast service on a plurality of carriers, the DAIs of the DCI formats for the unicast service and at least one multicast service may be counted together.

For example, in some embodiments, the value of a DAI (e.g., a counter DAI) in a DCI format (e.g., “DCI format #F1”, which can be a unicast DCI format for the unicast service or a multicast DCI format for the at least one multicast service) may indicate the accumulative number of transmitted DCI formats for the unicast service and the at least one multicast service (e.g., unicast DCI formats with the CRC scrambled by the C-RNTI and multicast DCI formats with the CRC scrambled by the G-RNTI(s) of the at least one multicast service) with HARQ-ACK feedback for the scheduled PDSCHs to be transmitted in the same slot. The accumulative number may be counted up to the current serving cell (e.g., the serving cell or carrier where DCI format #F1 is transmitted) among the sets of serving cells where the unicast DCI formats for the unicast service and the multicast DCI formats for the at least one multicast service are configured to be monitored (e.g., the sets of carriers configured for receiving the unicast DCI formats and the at least one multicast service) and up to the current PDCCH monitoring occasion (e.g., the PDCCH monitoring occasion where DCI format #F1 is transmitted).

For example, the value of the DAI in DCI format #F1 may be firstly updated in a predefined order (e.g., an ascending order) of serving cell indexes among the sets of serving cells where the unicast DCI formats for the unicast service and the multicast DCI formats for the at least one multicast service are configured to be monitored, and then updated in a predefined order (e.g., an ascending order) of the PDCCH monitoring occasions.

In some embodiments, DCI format #F1 may include an additional DAI (e.g., total DAI). For example, when the number of serving cells in the sets of serving cells where the unicast DCI formats for the unicast service and the multicast DCI formats for the at least one multicast service are configured to be monitored is greater than 1, DCI format #F1 may include a counter DAI and a total DAI. Otherwise, if the number of serving cells is 1, DCI format #F1 may only include a single DAI (e.g., counter DAI).

The total DAI in DCI format #F1 may indicate the total number of transmitted DCI formats for the unicast service and the at least one multicast service (e.g., unicast DCI formats with the CRC scrambled by the C-RNTI and multicast DCI formats with the CRC scrambled by the G-RNTI(s) of the at least one multicast service) with HARQ-ACK feedback for the scheduled PDSCHs to be transmitted in the same slot. The total DAI may be counted up to the current PDCCH monitoring occasion among the sets of serving cells where the unicast DCI formats for the unicast service and the multicast DCI formats for the at least one multicast service are configured to be monitored.

The HARQ-ACK codebook may include HARQ-ACK information bits for the unicast service and HARQ-ACK information bits for the at least one multicast service. The HARQ-ACK information bits may be ordered according to a predefined order (e.g., an ascending order) of the DAIs (e.g., the counter DAIs). When, for example, the number of carriers configured for the uncast service and the at least one multicast service is greater than 1, the size of the HARQ-ACK codebook may be determined based on the value of the total DAI. In some embodiments, the same HARQ-ACK codebook type (e.g., a Type-1 HARQ-ACK codebook or Type-2 HARQ-ACK codebook) is configured for the unicast service and the at least one multicast service.

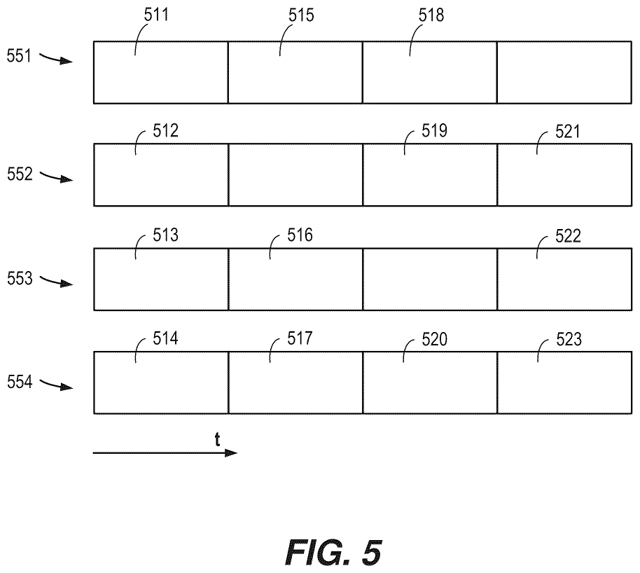

For example, FIG. 5 illustrates a schematic diagram of HARQ-ACK codebook determination in accordance with some embodiments of the present disclosure. Referring to FIG. 5, a UE may be configured with a plurality of CCs (e.g., CCs 551-554 in FIG. 5). In some examples, unicast DCI formats may be configured to be monitored on CC 551. Multicast DCI formats with a CRC scrambled by a G-RNTI (e.g., G-RNTI #G1 corresponding to multicast service #G1) may be configured to be monitored on CC 552. Multicast DCI formats with a CRC scrambled by another G-RNTI (e.g., G-RNTI #G2 corresponding to multicast service #G2) are configured to be monitored only on CC 553. Multicast DCI formats with a CRC scrambled by yet another G-RNTI (e.g., G-RNTI #G3 corresponding to multicast service #G3) are configured to be monitored only on CC 554. Therefore, the unicast DCI formats and the multicast DCI formats for multicast services #G1- #G3 may include a counter DAI and a total DAI.

For simplicity, it is assumed that the value of the serving cell index of CC 551<the value of the serving cell index of CC 552<the value of the serving cell index of CC 553<the value of the serving cell index of CC 554.

In some examples, the counter DAI in a unicast DCI format for the unicast service or a multicast DCI format for any of multicast services #G1- #G3 may indicate an accumulative number of transmitted DCI formats on CCs 551-554. The total DAI in a unicast DCI format for the unicast service or a multicast DCI format for any of multicast services #G1- #G3 may indicate the total number of transmitted DCI formats on CCs 551-554.

For example, assuming that DCI formats 511-523 are transmitted on CCs 551-554, each of DCI formats 511-523 may include a counter DAI and a total DAI. The {counter DAI, total DAI} value in DCI formats 511-523 may indicate {1,4}, {2,4}, {3,4}, {4,4}, {5,7}, {6,7}, {7,7}, {8,10}, {9,10}, {10,10}, {11,13}, {12,13}, and {13, 13}, respectively. Among DCI formats 511-523, DCI formats 511, 515, and 518 on CC 551 are for the unicast service, DCI formats 512, 519, and 521 on CC 552 are for multicast service #G1, DCI formats 513, 516, and 522 on CC 553 are for multicast service #G2, and DCI formats 514, 517, 520, and 523 on CC 554 are for multicast service #G3.

Assuming that HARQ-ACK feedback associated with DCI formats 511-523 are to be transmitted in the same slot, the UE may generate a HARQ-ACK codebook including HARQ-ACK information bits for the unicast service and multicast services #G1- #G3. The HARQ-ACK information bits may be ordered according to the DAIs. For example, the HARQ-ACK codebook may be generated as {a1, a2,a3,a4,a5,a6,a7,a8,a9,a10,a11,a12,a13}, wherein a1-a13 are HARQ-ACK information bits for the PDSCHs scheduled by DCI formats 511-523, respectively.

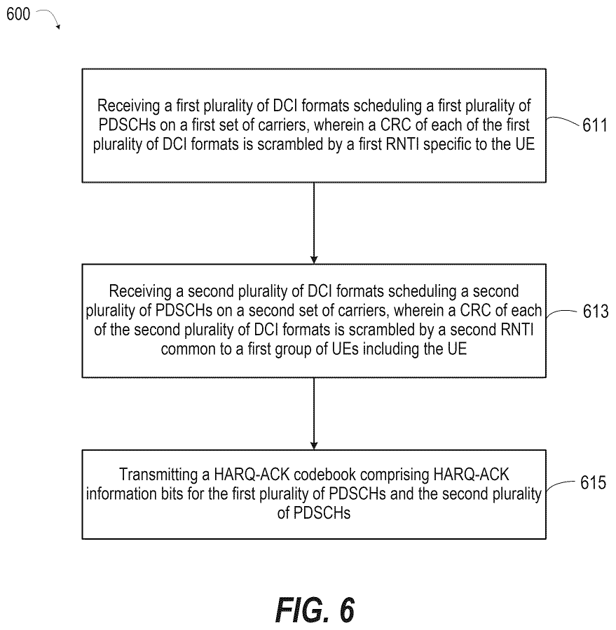

FIG. 6 illustrates a flow chart of an exemplary procedure 600 for wireless communications in accordance with some embodiments of the present disclosure. Details described in all of the foregoing embodiments of the present disclosure are applicable for the embodiments shown in FIG. 6. In some examples, the procedure may be performed by a UE, for example, UE 101 in FIG. 1.

Referring to FIG. 6, in operation 611, a UE may receive a first plurality of DCI formats scheduling a first plurality of PDSCHs on a first set of carriers, wherein a CRC of each of the first plurality of DCI formats is scrambled by a first RNTI specific to the UE.

In operation 613, the UE may receive a second plurality of DCI formats scheduling a second plurality of PDSCHs on a second set of carriers, wherein a CRC of each of the second plurality of DCI formats is scrambled by a second RNTI common to a first group of UEs including the UE.

In operation 615, the UE may transmit a HARQ-ACK codebook including HARQ-ACK information bits for the first plurality of PDSCHs and the second plurality of PDSCHs.

In some embodiments of the present disclosure, each of the first plurality of DCI formats may include a first DAI (e.g., a counter DAI). The first DAI may indicate an accumulative number of transmitted DCI formats among the first plurality of DCI formats. In some examples, the value of the first DAI may be firstly updated in a predefined order (e.g., an ascending order) of serving cell indexes among the first set of carriers and then updated in a predefined order of PDCCH monitoring occasions.

In some examples, in the case that the number of carriers in the first set of carriers is greater than 1, each of the first plurality of DCI formats may include a second DAI (e.g., total DAI). The second DAI may indicate a total number of transmitted DCI formats among the first plurality of DCI formats. The value of the second DAI may be updated in a predefined order of PDCCH monitoring occasions.

In some examples, each of the second plurality of DCI formats may include a first DAI (e.g., a counter DAI). The first DAI may indicate an accumulative number of transmitted DCI formats among the second plurality of DCI formats. The value of the first DAI may be firstly updated in a predefined order of serving cell indexes among the second set of carriers and then updated in a predefined order of PDCCH monitoring occasions.

In some examples, in the case that the number of carriers in the second set of carriers is greater than 1, each of the second plurality of DCI formats may include a second DAI (e.g., total DAI). The second DAI may indicate a total number of transmitted DCI formats among the second plurality of DCI formats. The value of the second DAI may be updated in a predefined order of PDCCH monitoring occasions.

In some examples, the HARQ-ACK codebook may include a first sub-codebook including the HARQ-ACK information bits for the first plurality of PDSCHs and a second sub-codebook including the HARQ-ACK information bits for the second plurality of PDSCHs. The HARQ-ACK information bits in the first sub-codebook may be arranged according to DAIs of the first plurality of DCI formats. The HARQ-ACK information bits in the second sub-codebook may be arranged according to DAIs of the second plurality of DCI formats.

In some examples, the first sub-codebook and the second sub-codebook may be arranged in the HARQ-ACK codebook according to the serving cell indexes of the first set of carriers and the second set of carriers.

In some examples, the UE may further receive a third plurality of DCI formats scheduling a third plurality of PDSCHs on a third set of carriers, and a CRC of each of the third plurality of DCI formats may be scrambled by a third RNTI common to a second group of UEs including the UE. The HARQ-ACK codebook may further include a third sub-codebook including HARQ-ACK information bits for the third plurality of PDSCHs. The first sub-codebook may be placed at a predefined location in the HARQ-ACK codebook. The second sub-codebook and the third sub-codebook may be arranged in the HARQ-ACK codebook according to the second RNTI, the third RNTI, the serving cell indexes of the second set of carriers and the third set of carriers, or any combination thereof.

In some examples, the first sub-codebook and the second sub-codebook may be configured with the same or different HARQ-ACK codebook types. In some examples, the second sub-codebook and the third sub-codebook may be configured with the same or different HARQ-ACK codebook types.

In some other embodiments of the present disclosure, the UE may further receive a third plurality of DCI formats scheduling a third plurality of PDSCHs on a third set of carriers, and a CRC of each of the third plurality of DCI formats may be scrambled by a third RNTI common to a second group of UEs including the UE. Each of the first plurality of DCI formats, the second plurality of DCI formats, and the third plurality of DCI formats may include a first DAI (e.g., a counter DAI). The first DAIs of the first plurality of DCI formats may be updated only among the first plurality of DCI formats and separately from the first DAIs of the second plurality of DCI formats and the third plurality of DCI formats which may be updated among the second plurality of DCI formats and the third plurality of DCI formats.

In some examples, the first DAIs in the second plurality of DCI formats and the third plurality of DCI formats may indicate accumulative numbers of transmitted DCI formats among the second plurality of DCI formats and the third plurality of DCI formats. The values of the first DAIs in the second plurality of DCI formats and the third plurality of DCI formats may be firstly updated in a predefined order of serving cell indexes among the second set of carriers and the third set of carriers and then updated in a predefined order of PDCCH monitoring occasions.

In some examples, in the case that the number of carriers in a combination of the second set of carriers and the third set of carriers is greater than 1, each of the second plurality of DCI formats and the third plurality of DCI formats may include a second DAI (e.g., total DAI). The second DAI may indicate a total number of transmitted DCI formats among the second plurality of DCI formats and the third plurality of DCI formats. The value of the second DAI may be updated in a predefined order of PDCCH monitoring occasions.

In some examples, the HARQ-ACK codebook may include a first sub-codebook including HARQ-ACK information bits for the first plurality of PDSCHs and a second sub-codebook including HARQ-ACK information bits for the second plurality of PDSCHs and the third plurality of PDSCHs. The HARQ-ACK information bits in the first sub-codebook may be arranged according to the first DAIs of the first plurality of DCI formats. The HARQ-ACK information bits in the second sub-codebook may be arranged according to the first DAIs of the second plurality of DCI formats and the third plurality of DCI formats. The first sub-codebook and the second sub-codebook may be arranged in the HARQ-ACK codebook according to a predefined order.

In some examples, the same HARQ-ACK codebook type may be configured for the second plurality of PDSCHs and the third plurality of PDSCHs. In some examples, the same or different HARQ-ACK codebook types may be configured for the first plurality of PDSCHs and the second plurality of PDSCHs.

In yet other embodiments of the present disclosure, each of the first plurality of DCI formats and the second plurality of DCI formats may include a first DAI (e.g., a counter DAI). The first DAI may indicate an accumulative number of transmitted DCI formats among the first plurality of DCI formats and the second plurality of DCI formats. The HARQ-ACK information bits for the first plurality of PDSCHs and the second plurality of PDSCHs may be arranged in the HARQ-ACK codebook according to the first DAI.

In some examples, the value of the first DAI may be firstly updated in a predefined order of serving cell indexes among the first set of carriers and the second set of carriers and then updated in a predefined order of PDCCH monitoring occasions.

In some examples, in the case that the number of carriers in a combination of the first set of carriers and the second set of carriers is greater than 1, each of the first plurality of DCI formats and the second plurality of DCI formats may include a second DAI. The second DAI may indicate a total number of transmitted DCI formats among the first plurality of DCI formats and the second plurality of DCI formats. The value of the second DAI may be updated in a predefined order of PDCCH monitoring occasions.

In some examples, the same HARQ-ACK codebook type may be configured for the first plurality of PDSCHs and the second plurality of PDSCHs.

It should be appreciated by persons skilled in the art that the sequence of the operations in exemplary procedure 600 may be changed and some of the operations in exemplary procedure 600 may be eliminated or modified, without departing from the spirit and scope of the disclosure.

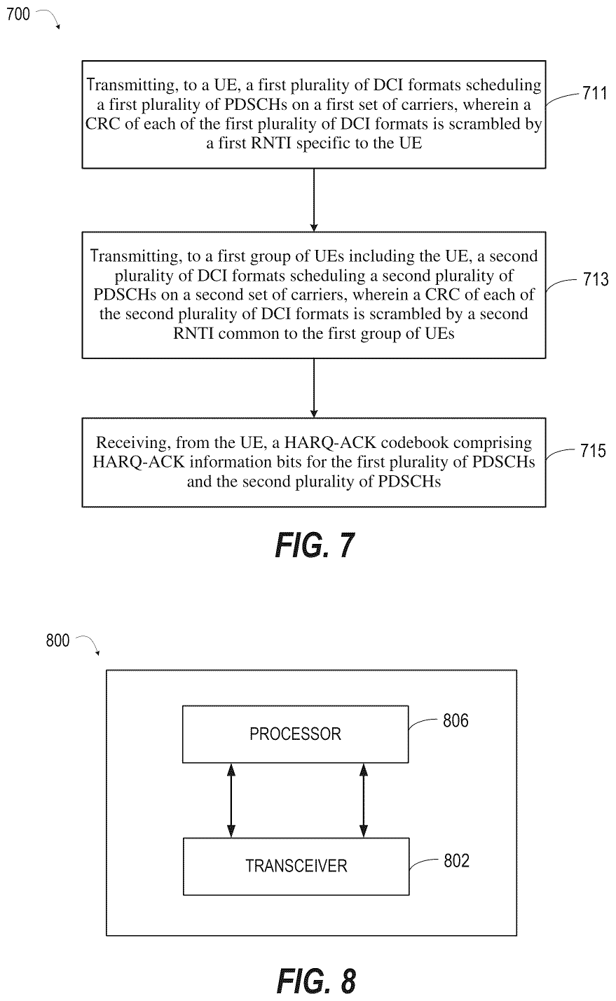

FIG. 7 illustrates a flow chart of an exemplary procedure 700 for wireless communications in accordance with some embodiments of the present disclosure. Details described in all of the foregoing embodiments of the present disclosure are applicable for the embodiments shown in FIG. 7. In some examples, the procedure may be performed by a BS, for example, BS 102 in FIG. 1.

Referring to FIG. 7, in operation 711, a BS may transmit, to a UE, a first plurality of DCI formats scheduling a first plurality of PDSCHs on a first set of carriers, wherein a CRC of each of the first plurality of DCI formats is scrambled by a first RNTI specific to the UE.

In operation 713, the BS may transmit, to a first group of UEs including the UE, a second plurality of DCI formats scheduling a second plurality of PDSCHs on a second set of carriers, wherein a CRC of each of the second plurality of DCI formats is scrambled by a second RNTI common to the first group of UEs.

In operation 715, the BS may receive, from the UE, a HARQ-ACK codebook including HARQ-ACK information bits for the first plurality of PDSCHs and the second plurality of PDSCHs.

In some embodiments of the present disclosure, each of the first plurality of DCI formats may include a first DAI (e.g., a counter DAI). The first DAI may indicate an accumulative number of transmitted DCI formats among the first plurality of DCI formats. In some examples, the value of the first DAI may be firstly updated in a predefined order of serving cell indexes among the first set of carriers and then updated in a predefined order of PDCCH monitoring occasions.

In some examples, in the case that the number of carriers in the first set of carriers is greater than 1, each of the first plurality of DCI formats may include a second DAI (e.g., total DAI). The second DAI may indicate a total number of transmitted DCI formats among the first plurality of DCI formats. The value of the second DAI may be updated in a predefined order of PDCCH monitoring occasions.

In some examples, each of the second plurality of DCI formats may include a first DAI. The first DAI may indicate an accumulative number of transmitted DCI formats among the second plurality of DCI formats. The value of the first DAI may be firstly updated in a predefined order of serving cell indexes among the second set of carriers and then updated in a predefined order of PDCCH monitoring occasions.

In some examples, in the case that the number of carriers in the second set of carriers is greater than 1, each of the second plurality of DCI formats may include a second DAI (e.g., total DAI). The second DAI may indicate a total number of transmitted DCI formats among the second plurality of DCI formats. The value of the second DAI may be updated in a predefined order of PDCCH monitoring occasions.

In some examples, the HARQ-ACK codebook may include a first sub-codebook including the HARQ-ACK information bits for the first plurality of PDSCHs and a second sub-codebook including the HARQ-ACK information bits for the second plurality of PDSCHs. The HARQ-ACK information bits in the first sub-codebook may be arranged according to DAIs of the first plurality of DCI formats. The HARQ-ACK information bits in the second sub-codebook may be arranged according to DAIs of the second plurality of DCI formats.

In some examples, the first sub-codebook and the second sub-codebook may be arranged in the HARQ-ACK codebook according to the serving cell indexes of the first set of carriers and the second set of carriers.

In some examples, the BS may further transmit, to a second group of UEs including the UE, a third plurality of DCI formats scheduling a third plurality of PDSCHs on a third set of carriers, and a CRC of each of the third plurality of DCI formats may be scrambled by a third RNTI common to the second group of UEs. The HARQ-ACK codebook may further include a third sub-codebook including HARQ-ACK information bits for the third plurality of PDSCHs. The first sub-codebook may be placed at a predefined location in the HARQ-ACK codebook. The second sub-codebook and the third sub-codebook may be arranged in the HARQ-ACK codebook according to the second RNTI, the third RNTI, the serving cell indexes of the second set of carriers and the third set of carriers, or any combination thereof.

In some examples, the first sub-codebook and the second sub-codebook may be configured with the same or different HARQ-ACK codebook types. In some examples, the second sub-codebook and the third sub-codebook may be configured with the same or different HARQ-ACK codebook types.

In some other embodiments of the present disclosure, the BS may further transmit, to a second group of UEs including the UE, a third plurality of DCI formats scheduling a third plurality of PDSCHs on a third set of carriers, and a CRC of each of the third plurality of DCI formats may be scrambled by a third RNTI common to the second group of UEs. Each of the first plurality of DCI formats, the second plurality of DCI formats, and the third plurality of DCI formats may include a first DAI. The first DAI of the first plurality of DCI formats may be updated only among the first plurality of DCI formats and separately from the first DAI of the second plurality of DCI formats and the third plurality of DCI formats which may be updated among the second plurality of DCI formats and the third plurality of DCI formats.

In some examples, the first DAI in the second plurality of DCI formats and the third plurality of DCI formats may indicate accumulative numbers of transmitted DCI formats among the second plurality of DCI formats and the third plurality of DCI formats. The values of the first DAI in the second plurality of DCI formats and the third plurality of DCI formats may be firstly updated in a predefined order of serving cell indexes among the second set of carriers and the third set of carriers and then updated in a predefined order of PDCCH monitoring occasions.

In some examples, in the case that the number of carriers in a combination of the second set of carriers and the third set of carriers is greater than 1, each of the second plurality of DCI formats and the third plurality of DCI formats may include a second DAI. The second DAI may indicate a total number of transmitted DCI formats among the second plurality of DCI formats and the third plurality of DCI formats. The value of the second DAI may be updated in a predefined order of PDCCH monitoring occasions.

In some examples, the HARQ-ACK codebook may include a first sub-codebook including HARQ-ACK information bits for the first plurality of PDSCHs and a second sub-codebook including HARQ-ACK information bits for the second plurality of PDSCHs and the third plurality of PDSCHs. The HARQ-ACK information bits in the first sub-codebook may be arranged according to the first DAI of the first plurality of DCI formats. The HARQ-ACK information bits in the second sub-codebook may be arranged according to the first DAI of the second plurality of DCI formats and the third plurality of DCI formats. The first sub-codebook and the second sub-codebook may be arranged in the HARQ-ACK codebook according to a predefined order.

In some examples, the same HARQ-ACK codebook type may be configured for the second plurality of PDSCHs and the third plurality of PDSCHs. In some examples, the same or different HARQ-ACK codebook types may be configured for the first plurality of PDSCHs and the second plurality of PDSCHs.

In yet other embodiments of the present disclosure, each of the first plurality of DCI formats and the second plurality of DCI formats may include a first DAI. The first DAI may indicate an accumulative number of transmitted DCI formats among the first plurality of DCI formats and the second plurality of DCI formats. The HARQ-ACK information bits for the first plurality of PDSCHs and the second plurality of PDSCHs may be arranged in the HARQ-ACK codebook according to the first DAI.

In some examples, the value of the first DAI may be firstly updated in a predefined order of serving cell indexes among the first set of carriers and the second set of carriers and then updated in a predefined order of PDCCH monitoring occasions.

In some examples, in the case that the number of carriers in a combination of the first set of carriers and the second set of carriers is greater than 1, each of the first plurality of DCI formats and the second plurality of DCI formats may include a second DAI. The second DAI may indicate a total number of transmitted DCI formats among the first plurality of DCI formats and the second plurality of DCI formats. The value of the second DAI may be updated in a predefined order of PDCCH monitoring occasions.

In some examples, the same HARQ-ACK codebook type may be configured for the first plurality of PDSCHs and the second plurality of PDSCHs.

It should be appreciated by persons skilled in the art that the sequence of the operations in exemplary procedure 700 may be changed and some of the operations in exemplary procedure 700 may be eliminated or modified, without departing from the spirit and scope of the disclosure.

FIG. 8 illustrates a block diagram of an exemplary apparatus 800 according to some embodiments of the present disclosure. As shown in FIG. 8, the apparatus 800 may include at least one processor 806 and at least one transceiver 802 coupled to the processor 806. The apparatus 800 may be a UE or a BS.

Although in this figure, elements such as the at least one transceiver 802 and processor 806 are described in the singular, the plural is contemplated unless a limitation to the singular is explicitly stated. In some embodiments of the present application, the transceiver 802 may be divided into two devices, such as a receiving circuitry and a transmitting circuitry. In some embodiments of the present application, the apparatus 800 may further include an input device, a memory, and/or other components.

In some embodiments of the present application, the apparatus 800 may be a UE. The transceiver 802 and the processor 806 may interact with each other so as to perform the operations with respect to the UE described in FIGS. 1-7. In some embodiments of the present application, the apparatus 800 may be a BS. The transceiver 802 and the processor 806 may interact with each other so as to perform the operations with respect to the BS described in FIGS. 1-7.

In some embodiments of the present application, the apparatus 800 may further include at least one non-transitory computer-readable medium.

For example, in some embodiments of the present disclosure, the non-transitory computer-readable medium may have stored thereon computer-executable instructions to cause the processor 806 to implement the method with respect to the UE as described above. For example, the computer-executable instructions, when executed, cause the processor 806 interacting with transceiver 802 to perform the operations with respect to the UE described in FIGS. 1-7.

In some embodiments of the present disclosure, the non-transitory computer-readable medium may have stored thereon computer-executable instructions to cause the processor 806 to implement the method with respect to the BS as described above. For example, the computer-executable instructions, when executed, cause the processor 806 interacting with transceiver 802 to perform the operations with respect to the BS described in FIGS. 1-7.

Those having ordinary skill in the art would understand that the operations or steps of a method described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. Additionally, in some aspects, the operations or steps of a method may reside as one or any combination or set of codes and/or instructions on a non-transitory computer-readable medium, which may be incorporated into a computer program product.

While this disclosure has been described with specific embodiments thereof, it is evident that many alternatives, modifications, and variations may be apparent to those skilled in the art. For example, various components of the embodiments may be interchanged, added, or substituted in other embodiments. Also, all of the elements of each figure are not necessary for the operation of the disclosed embodiments. For example, one of ordinary skill in the art of the disclosed embodiments would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, the terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The term “having” and the like, as used herein, are defined as “including.” Expressions such as “A and/or B” or “at least one of A and B” may include any and all combinations of words enumerated along with the expression. For instance, the expression “A and/or B” or “at least one of A and B” may include A, B, or both A and B. The wording “the first,” “the second” or the like is only used to clearly illustrate the embodiments of the present application, but is not used to limit the substance of the present application.

1. A user equipment (UE) for wireless communication, the UE comprising:
a processor; and
a memory coupled to the processor;
a transceiver coupled to the processor
wherein the processor is configured to cause the UE to:
receive, via the transceiver, a first plurality of downlink control information (DCI) formats scheduling a first plurality of physical downlink shared channels (PDSCHs) on a first set of carriers, wherein a cyclic redundancy check (CRC) of each of the first plurality of DCI formats is scrambled by a first radio network temporary identifier (RNTI) specific to the UE;
receive, via the transceiver, a second plurality of DCI formats scheduling a second plurality of PDSCHs on a second set of carriers, wherein a CRC of each of the second plurality of DCI formats is scrambled by a second RNTI common to a first group of UEs including the UE; and
transmit, via the transceiver, a hybrid automatic repeat request acknowledgement (HARQ-ACK) codebook comprising HARQ-ACK information bits for the first plurality of PDSCHs and the second plurality of PDSCHs.

2. The UE of claim 1, wherein:
each of the first plurality of DCI formats comprises a first downlink assignment index (DAI), and the first DAI in each of the first plurality of DCI formats indicates an accumulative number of transmitted DCI formats among the first plurality of DCI formats; and
each of the second plurality of DCI formats comprises a first DAI, and the first DAI in each of the second plurality of DCI formats indicates an accumulative number of transmitted DCI formats among the second plurality of DCI formats.

3. The UE of claim 2, wherein:
the value of the first DAI in each of the first plurality of DCI formats is firstly updated in a predefined order of serving cell indexes among the first set of carriers and then updated in a predefined order of physical downlink control channel (PDCCH) monitoring occasions; and
the value of the first DAI in each of the second plurality of DCI formats is firstly updated in a predefined order of serving cell indexes among the second set of carriers and then updated in a predefined order of PDCCH monitoring occasions.

4. The UE of claim 1, wherein in the case that the number of carriers in the first set of carriers is greater than 1, each of the first plurality of DCI formats comprises a second downlink assignment index (DAI) that indicates a total number of transmitted DCI formats among the first plurality of DCI formats.

5. The UE of claim 1, wherein in the case that the number of carriers in the second set of carriers is greater than 1, each of the second plurality of DCI formats comprises a second downlink assignment index (DAI), and wherein the second DAI that indicates a total number of transmitted DCI formats among the second plurality of DCI formats.

6. The UE of claim 1, wherein:
the HARQ-ACK codebook includes a first sub-codebook including the HARQ-ACK information bits for the first plurality of PDSCHs and a second sub-codebook including the HARQ-ACK information bits for the second plurality of PDSCHs; and
HARQ-ACK information bits in the first sub-codebook are arranged according to downlink assignment indexes (DAIs) of the first plurality of DCI formats, and HARQ-ACK information bits in the second sub-codebook are arranged according to DAIs of the second plurality of DCI formats.

7. The UE of claim 6, wherein the first sub-codebook and the second sub-codebook are arranged in the HARQ-ACK codebook according to the serving cell indexes of the first set of carriers and the second set of carriers.

8. The UE of claim 6, wherein the first sub-codebook is placed at a predefined location in the HARQ-ACK codebook.

9. The UE of claim 8, wherein:
the processor is further configured cause the UE to receive, via the transceiver, a third plurality of DCI formats scheduling a third plurality of PDSCHs on a third set of carriers, and a CRC of each of the third plurality of DCI formats is scrambled by a third RNTI common to a second group of UEs including the UE;
the HARQ-ACK codebook further includes a third sub-codebook including HARQ-ACK information bits for the third plurality of PDSCHs; and
the second sub-codebook and the third sub-codebook are arranged in the HARQ-ACK codebook according to the second RNTI, the third RNTI, the serving cell indexes of the second set of carriers and the third set of carriers, or any combination thereof.

10. The UE of claim 9, wherein the first sub-codebook and the second sub-codebook are configured with different HARQ-ACK codebook types.

11. The UE of claim 9, wherein the second sub-codebook and the third sub-codebook are configured with different HARQ-ACK codebook types.

12. The UE of claim 1, wherein:
the processor is further configured cause the UE to receive, via the transceiver, a third plurality of DCI formats scheduling a third plurality of PDSCHs on a third set of carriers, and a CRC of each of the third plurality of DCI formats is scrambled by a third RNTI common to a second group of UEs including the UE; and
each of the first plurality of DCI formats, the second plurality of DCI formats, and the third plurality of DCI formats comprises a first downlink assignment index (DAI), and the first DAIs of the first plurality of DCI formats are updated only among the first plurality of DCI formats and separately from the first DAIs of the second plurality of DCI formats and the third plurality of DCI formats which are updated among the second plurality of DCI formats and the third plurality of DCI formats.

13. The UE of claim 1, wherein:
each of the first plurality of DCI formats and the second plurality of DCI formats comprises a first downlink assignment index (DAI), and the first DAI indicates an accumulative number of transmitted DCI formats among the first plurality of DCI formats and the second plurality of DCI formats; and
HARQ-ACK information bits for the first plurality of PDSCHs and the second plurality of PDSCHs are arranged in the HARQ-ACK codebook according to the first DAI.

14-15. (canceled)

16. A processor for wireless communication by a user equipment (UE), the processor configured to:
receive a first plurality of downlink control information (DCI) formats scheduling a first plurality of physical downlink shared channels (PDSCHs) on a first set of carriers, wherein a cyclic redundancy check (CRC) of each of the first plurality of DCI formats is scrambled by a first radio network temporary identifier (RNTI) specific to the UE;
receive a second plurality of DCI formats scheduling a second plurality of PDSCHs on a second set of carriers, wherein a CRC of each of the second plurality of DCI formats is scrambled by a second RNTI common to a first group of UEs including the UE; and
generate and transmit a hybrid automatic repeat request acknowledgement (HARQ-ACK) codebook comprising HARQ-ACK information bits for the first plurality of PDSCHs and the second plurality of PDSCHs.

17. The processor of claim 16, wherein:
each of the first plurality of DCI formats comprises a first downlink assignment index (DAI), and the first DAI in each of the first plurality of DCI formats indicates an accumulative number of transmitted DCI formats among the first plurality of DCI formats; and
each of the second plurality of DCI formats comprises a first DAI, and the first DAI in each of the second plurality of DCI formats indicates an accumulative number of transmitted DCI formats among the second plurality of DCI formats.

18. The processor of claim 17, wherein:
the value of the first DAI in each of the first plurality of DCI formats is firstly updated in a predefined order of serving cell indexes among the first set of carriers and then updated in a predefined order of physical downlink control channel (PDCCH) monitoring occasions; and
the value of the first DAI in each of the second plurality of DCI formats is firstly updated in a predefined order of serving cell indexes among the second set of carriers and then updated in a predefined order of PDCCH monitoring occasions.

19. The processor of claim 16, wherein:
the processor is further configured to receive a third plurality of DCI formats scheduling a third plurality of PDSCHs on a third set of carriers, and a CRC of each of the third plurality of DCI formats is scrambled by a third RNTI common to a second group of UEs including the UE; and
each of the first plurality of DCI formats, the second plurality of DCI formats, and the third plurality of DCI formats comprises a first downlink assignment index (DAI), and the first DAIs of the first plurality of DCI formats are updated only among the first plurality of DCI formats and separately from the first DAIs of the second plurality of DCI formats and the third plurality of DCI formats which are updated among the second plurality of DCI formats and the third plurality of DCI formats.

20. A method for wireless communication performed by a user equipment (UE), the method comprising:
receiving a first plurality of downlink control information (DCI) formats scheduling a first plurality of physical downlink shared channels (PDSCHs) on a first set of carriers, wherein a cyclic redundancy check (CRC) of each of the first plurality of DCI formats is scrambled by a first radio network temporary identifier (RNTI) specific to the UE;
receiving a second plurality of DCI formats scheduling a second plurality of PDSCHs on a second set of carriers, wherein a CRC of each of the second plurality of DCI formats is scrambled by a second RNTI common to a first group of UEs including the UE; and
transmitting a hybrid automatic repeat request acknowledgement (HARQ-ACK) codebook comprising HARQ-ACK information bits for the first plurality of PDSCHs and the second plurality of PDSCHs.

21. A base station (BS), comprising:
a memory;
a transceiver; and
a processor coupled to the memory and to the transceiver, the processor configured to cause the base station to:
transmit, to a user equipment (UE), a first plurality of downlink control information (DCI) formats scheduling a first plurality of physical downlink shared channels (PDSCHs) on a first set of carriers, wherein a cyclic redundancy check (CRC) of each of the first plurality of DCI formats is scrambled by a first radio network temporary identifier (RNTI) specific to the UE;
transmit, to a first group of UEs including the UE, a second plurality of DCI formats scheduling a second plurality of PDSCHs on a second set of carriers, wherein a CRC of each of the second plurality of DCI formats is scrambled by a second RNTI common to the first group of UEs; and
receive, from the UE, a hybrid automatic repeat request acknowledgement (HARQ-ACK) codebook comprising HARQ-ACK information bits for the first plurality of PDSCHs and the second plurality of PDSCHs.

22. The base station of claim 21, wherein the processor is further configured to cause the base station to:
transmit a third plurality of DCI formats scheduling a third plurality of PDSCHs on a third set of carriers, and a CRC of each of the third plurality of DCI formats is scrambled by a third RNTI common to a second group of UEs including the UE;
wherein each of the first plurality of DCI formats, the second plurality of DCI formats, and the third plurality of DCI formats comprises a first downlink assignment index (DAI), and the first DAIs of the first plurality of DCI formats are updated only among the first plurality of DCI formats and separately from the first DAIs of the second plurality of DCI formats and the third plurality of DCI formats which are updated among the second plurality of DCI formats and the third plurality of DCI formats.
